(19) United States
(12) Patent Application Publication
(10) Pub. No.: US 2015/0324127 A1
(43) Pub. Date: Nov. 12, 2015

(54) STORAGE CONTROL APPARATUS AND STORAGE CONTROL METHOD

(71) Applicant: FUJITSU LIMITED, Kawasaki-shi (JP)

(72) Inventor: Hidekazu KAWANO, Saitama (JP)

(73) Assignee: FUJITSU LIMITED, Kawasaki-shi (JP)

(21) Appl. No.: 14/631,246

(22) Filed: Feb. 25, 2015

(30) Foreign Application Priority Data
May 9, 2014 (JP) 2014-097250

(51) Int. Cl. G06F 3/06

(52) U.S. Cl. CPC G06F 3/0604; G06F 3/0631; G06F 3/0644; G06F 3/0665; G06F 3/0685

(57) ABSTRACT

A storage control apparatus includes a processor. The processor is configured to create management information upon detecting a connection with an information processing apparatus. The processor is configured to set a first logical volume for the information processing apparatus in the management information. The first logical volume is allocated with no physical storage region. The processor is configured to convert, upon receiving a write request for the first logical volume from the information processing apparatus, the first logical volume into a second logical volume by allocating a physical storage region to the first logical volume. The processor is configured to set the second logical volume in the management information.

### CROSS-REFERENCE TO RELATED APPLICATION

This application is based upon and claims the benefit of priority from the prior Japanese Patent Application No. 2014-097250 filed on May 9, 2014, the entire contents of which are incorporated herein by reference.

### FIELD

The embodiments discussed herein are related to a storage control apparatus and a storage control method.

### BACKGROUND

A technology called a thin provisioning (virtual provisioning) is known as a technology which enables preparing a logical volume such as a logical unit number (LUN), for example, having a virtual capacity more than a predetermined physical capacity on a disk array.

The LUN is used by a host, but the disk array is responsible for setting up the LUN, which includes preparing for the LUN. The disk array is able to identify the host by a world wide port name (WWPN), but is not able to recognize a host operation type. Therefore, in setting up of the LUN, a setting up according to the operation type such as a distinction between an operating host and a reserved host, a distinction between the users, and the like, is performed through the help of people.

Related techniques are disclosed in, for example, Japanese Laid-Open Patent Publication No. 2005-11316 and Japanese Laid-Open Patent Publication No. 2006-195712.

The administrator is required to prepare the LUN by designing the number of LUNs and the capacity of the LUN in order for the host to identify the LUN. The preparation of the LUN by the administrator is not limited to a case where the host newly introduces the LUN and is also needed for a case where a LUN is added, and an operation by the administrator is needed for each of the cases. The setting up of the LUN requires many operational processes and it is difficult to perform each of the processes in a timely manner.

### SUMMARY

According to an aspect of the present invention, provided is a storage control apparatus including a processor. The processor is configured to create management information upon detecting a connection with an information processing apparatus. The processor is configured to set a first logical volume for the information processing apparatus in the management information. The first logical volume is allocated with no physical storage region. The processor is configured to convert, upon receiving a write request for the first logical volume from the information processing apparatus, the first logical volume into a second logical volume by allocating a physical storage region to the first logical volume. The processor is configured to set the second logical volume in the management information.

The object and advantages of the invention will be realized and attained by means of the elements and combinations particularly pointed out in the claims. It is to be understood that both the foregoing general description and the following detailed description are exemplary and explanatory and are not restrictive of the invention, as claimed.

### BRIEF DESCRIPTION OF DRAWINGS

FIG. 1 is a diagram illustrating an exemplary configuration of a storage control apparatus according to a first embodiment;

FIG. 2 is a diagram illustrating an exemplary configuration of a storage system according to a second embodiment;

FIG. 3 is a diagram illustrating an exemplary hardware configuration of a storage apparatus according to the second embodiment and an example of a disk array connected with the storage apparatus;

FIG. 4 is a diagram illustrating an example of an operational procedure in the storage apparatus and in a FC switch at the time of new introduction according to the second embodiment;

FIG. 5 is a diagram illustrating an example of an association information table of a LUN group according to the second embodiment;

FIG. 6 is a flowchart of a CA port linking process according to the second embodiment;

FIG. 7 is a diagram illustrating an example of association information of a LUN table according to the second embodiment;

FIG. 8 is a diagram illustrating an example of a newly created LUN table according to the second embodiment;

FIG. 9 is a diagram illustrating an example of an operational procedure in the storage apparatus and in the host at the time of new introduction according to the second embodiment;

FIG. 10 is a flowchart of an actual LUN allocation process according to the second embodiment;

FIG. 11 is a diagram illustrating an example of a LUN table after the actual LUN allocation process is ended;

FIG. 12 is a diagram illustrating an example of an operational procedure in the storage apparatus and in the FC switch at the time of addition of a LUN according to the second embodiment;

FIG. 13 is a diagram illustrating an example for a LUN table for a LUN group which is different from a LUN group of the LUN table illustrated in FIG. 11;

FIG. 14 is a flowchart of an actual LUN deletion process according to the second embodiment;

FIG. 15 is a diagram illustrating an example of a LUN table after the actual LUN deletion process is ended;

FIG. 16 is a diagram illustrating an example of a LUN group association information table according to a third embodiment;

FIG. 17 is a diagram illustrating an example of LUN table association information according to the third embodiment;

FIG. 18 is a diagram illustrating an example of a LUN management tool according to the third embodiment; and

FIG. 19 is a flowchart of a LUN table addition process according to the third embodiment.

### DESCRIPTION OF EMBODIMENTS

Hereinafter, descriptions will be given on embodiments in detail with reference to accompanying drawings.

### First Embodiment

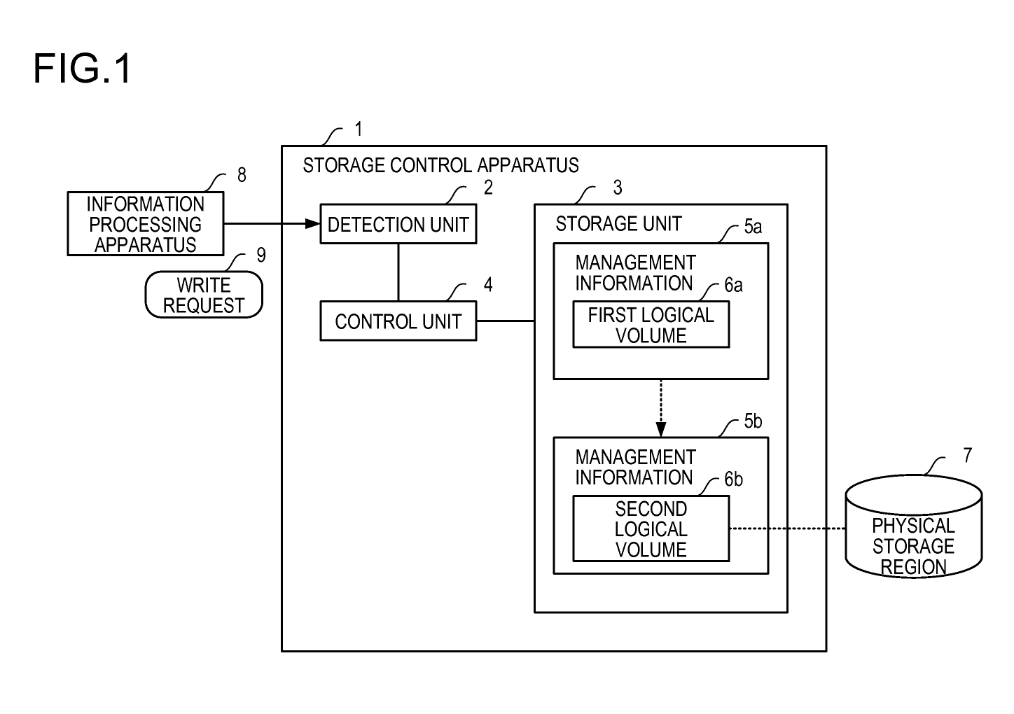

Descriptions will be given first on a storage control apparatus according to a first embodiment with reference to FIG. 1. FIG. 1 is a diagram illustrating an exemplary configuration of a storage control apparatus according to a first embodiment.

A storage control apparatus 1 receives an input/output (I/O) request for a logical volume 6 (6a, 6b) from an information processing apparatus 8 (host computer, for example). The logical volume 6 includes a first logical volume 6a and a second logical volume 6b. The first logical volume 6a is a logical volume to which a physical storage region 7 is not allocated. The second logical volume 6b is a logical volume to which the physical storage region 7 is allocated. The physical storage region 7 is constituted by a single storage apparatus or a combination of two or more storage apparatuses. The storage apparatus is, for example, a hard disk drive (HDD) or a solid state drive (SSD).

The storage control apparatus 1 includes a detection unit 2, a storage unit 3, and a control unit 4. The detection unit 2 detects connection with the information processing apparatus 8. The storage unit 3 stores management information 5 (5a, 5b) for managing the logical volume 6. The storage unit 3 is, for example, a random access memory (RAM) or an HDD. The management information 5 is information for managing the logical volume 6 in accordance with the settings for each information processing apparatus 8 which is detected as being connected with the storage control apparatus 1. The settings for each information processing apparatus 8 include, for example, information (WWPN, for example) capable of identifying the information processing apparatus 8. The management information 5 may be information for managing the settings for each information processing apparatus 8 and the logical volume 6 in association with each other. Otherwise, the management information 5 may be information for managing the logical volume 6 in association with the settings for each information processing apparatus 8 which is externally managed.

The management information 5 may be information for managing a user or a user group associated with each information processing apparatus 8 in a one-to-one relationship. Two or more users or user groups may be associated with a single information processing apparatus 8.

Upon detection of the connection with the information processing apparatus 8, the control unit 4 creates the management information 5 and sets, in the created management information 5, the first logical volume 6a to which the physical storage region 7 is not allocated, as the logical volume 6 of the information processing apparatus 8. Upon receipt of a write request 9 for the first logical volume 6a from the information processing apparatus 8, the control unit 4 allocates the physical storage region 7 to the first logical volume 6a, converts the first logical volume 6a into the second logical volume 6b to which the physical storage region 7 has been allocated, and sets the second logical volume 6b in the management information 5.

That is, upon the detection of the connection with the information processing apparatus 8, the control unit 4 creates the management information 5a and prepares the first logical volume 6a for the information processing apparatus 8. Upon receipt of the write request 9 for the first logical volume 6a from the information processing apparatus 8, the control unit 4 updates the management information 5a with the management information 5b. The write request 9 is one of I/O requests issued by the information processing apparatus 8. For example, the storage control apparatus 1 detects, by the receipt of the write request 9, that the write request 9 has been issued. In response to the write request 9, the storage control apparatus 1 performs a process including an access to the physical storage region 7 allocated to the logical volume 6.

The physical storage region 7 is not allocated to the first logical volume 6a. Further, the conversion from the first logical volume 6a to the second logical volume 6b is performed when the write request 9 which causes an access to the physical storage region 7 is issued. Thus, the storage control apparatus 1 may achieve an effective use of storage resources. Since the first logical volume 6a is associated with the management information 5 for each information processing apparatus 8 in advance, the storage control apparatus 1 does not perform the setting up of the management information 5 each time the first logical volume 6a is converted to the second logical volume 6b. Accordingly, the storage control apparatus 1 may reduce a work load for the setting up of the logical volume 6. Further, the information processing apparatus 8 is released from a processing load of requesting the administrator to perform the setting of the logical volume 6.

Since the first logical volume 6a is a form of the logical volume 6, the user who manipulates the information processing apparatus 8 may handle the first logical volume 6a in the same manner as that for handling the second logical volume 6b. However, since the physical storage region 7 is not allocated to the first logical volume 6a, the first logical volume 6a may be recognized as an insubstantial dummy logical volume for the storage control apparatus 1. Since the physical storage region 7 is allocated to the second logical volume 6b, the second logical volume 6b may be recognized as a substantial actual logical volume for the storage control apparatus 1.

### Second Embodiment

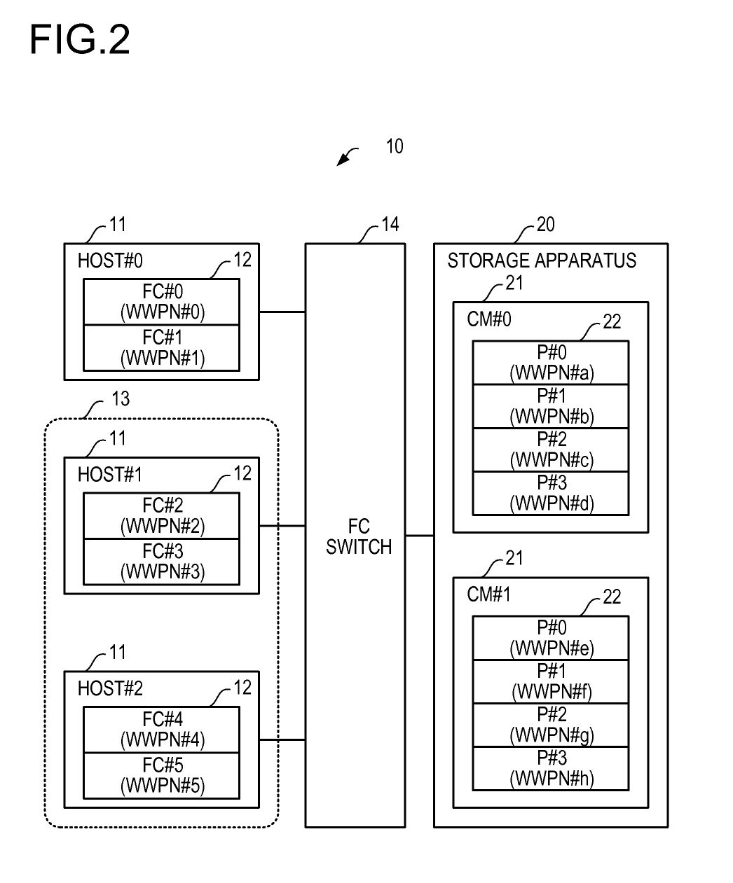

Next, descriptions will be given on a configuration of a storage system of a second embodiment with reference to FIG. 2. FIG. 2 is a diagram illustrating an exemplary configuration of a storage system according to the second embodiment.

A storage system 10 includes one or more hosts 11 and one or more storage apparatuses 20 communicably connected with the hosts 11. The host 11 is an example of an information processing apparatus. The storage apparatus 20 manages storage resources in a thin provisioning environment. The storage apparatus 20 is, for example, a redundant arrays of inexpensive disks (RAID) apparatus. The storage apparatus 20 provides a LUN, which is a logical volume to which a physical storage region is allocated, as a device which may be used by the host 11.

The host 11 may be connected with the storage apparatus 20 as a single node. The hosts 11 may be connected with the storage apparatus 20 as a cluster 13 including two or more nodes. For example, host#0 is connected with the storage apparatus 20 as a single node. For example, host#1 and host#2 are connected with the storage apparatus 20 as the cluster 13.

The storage apparatus 20 includes one or more controller modules (CMs) 21. The CM 21 is an example of a storage control apparatus and receives an I/O request (write request, read request, or the like) from the host 11 and controls accessing to the SSD or the HDD. The illustrated storage apparatus 20 has a redundant configuration including two CMs 21.

The host 11 and the storage apparatus 20 are connected with each other through a fibre channel (FC) switch 14. The host 11 includes a port 12 as an FC interface. For example, the host#0 includes FC#0 (WWPN#0) and a FC#1 (WWPN#1), the host#1 includes FC#2 (WWPN#2) and FC#3 (WWPN#3), and the host#2 includes FC#4 (WWPN#4) and FC#5 (WWPN#5). The CM 21 includes a port 22 as an FC interface. For example, CM#0 includes P#0 (WWPN#a), P#1 (WWPN#b), P#2 (WWPN#c), and P#3 (WWPN#d) and CM#1 includes P#0 (WWPN#e), P#1 (WWPN#f), P#2 (WWPN#g) and P#3 (WWPN#h).

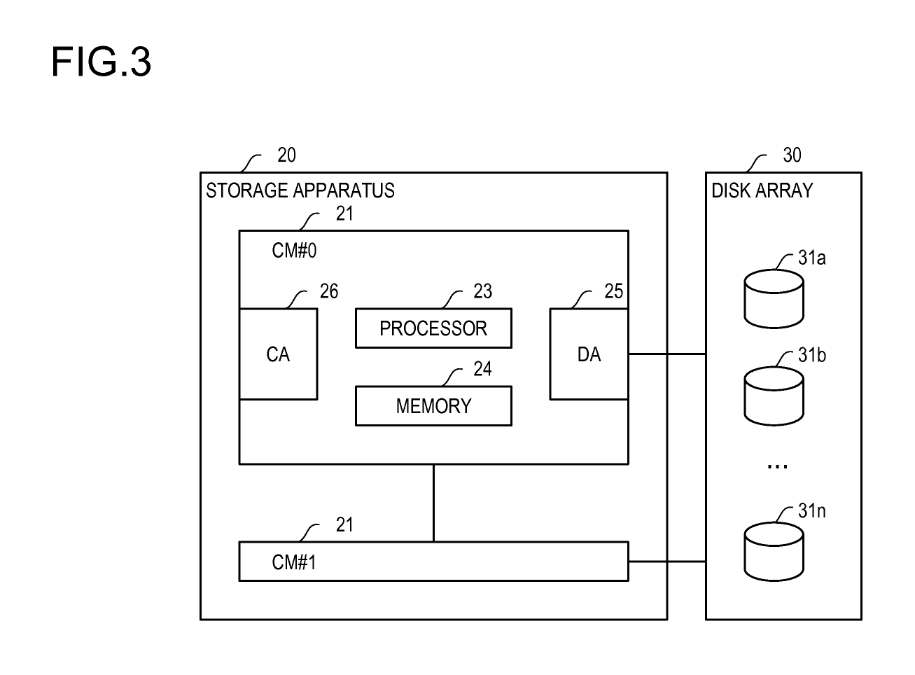

Next, descriptions will be given on a hardware configuration of a storage apparatus according to the second embodiment with reference to FIG. 3. FIG. 3 is a diagram illustrating an exemplary hardware configuration of a storage apparatus according to the second embodiment and an example of a disk array connected with the storage apparatus.

The storage apparatus 20 is connected with a disk array 30. The disk array 30 includes a plurality of HDDs 31 (31a, 31b, . . . , 31n). The HDD 31 is an example of a storage device and, for example, an SSD may be used instead of the HDD.

The disk array 30 includes an interface which connects the plurality of HDDs 31 with the storage apparatus 20. The storage apparatus 20 configures a logical volume with a single HDD 31 or a combination of two or more HDDs 31. The disk array 30 may be built in the storage apparatus 20 or externally attached to the storage apparatus 20. The illustrated storage apparatus 20 is connected with a single disk array 30, but may be connected with two or more disk arrays 30.

The storage apparatus 20 has a redundant configuration including two CMs 21 (CM#0 and CM#1). The CM#0 includes a processor 23, a memory 24, a disk adapter (DA) 25, and a channel adapter (CA) 26. The processor 23, the memory 24, the disk adapter 25, and the channel adapter 26 are connected with one another through a bus (not illustrated). The CM#0 is connected with the HDD 31 through the disk adapter 25 and with the host 11 through the channel adapter 26.

The processor 23 controls the entire CM#0 and also controls the HDD 31. The processor 23 may be a multiprocessor. The processor 23 is, for example, a central processing unit (CPU), a micro processing unit (MPU), a digital signal processor (DSP), an application specific integrated circuit (ASIC), or a programmable logic device (PLD). The processor 23 may be configured by a combination of two or more of the CPU, the MPU, the DSP, the ASIC, and the PLD.

The memory 24 includes, for example, a RAM or a nonvolatile memory. The memory 24 holds data when the data is read from the HDD 31 and also serves as a buffer when data is written into the HDD 31. Further, the memory 24 stores user data or control information. For example, the RAM is used as a main storage device of the CM#0. At least part of an operating system (OS) program, firmware, and an application program executed by the processor 23 is temporarily stored in the RAM. Further, various data used for the processing by the processor 23 are stored in the RAM. The RAM may include a cache memory separately from the memory used for storing various data.

The nonvolatile memory holds stored contents even when the power of the storage apparatus 20 is turned OFF. The nonvolatile memory is, for example, a semiconductor storage device such as an electrically erasable and programmable read-only memory (EEPROM) and a flash memory, or an HDD. The OS program, the firmware, the application program, and various data are stored in the nonvolatile memory.

The disk adapter 25 performs control (access control, for example) of interfacing with the HDD 31. The channel adapter 26 includes the port 22 and performs control (access control, for example) of interfacing with the host 11 through the port 22.

Since the CM#1 is similar to the CM#0, descriptions thereof will be omitted. With the hardware configuration described above, the processing functions of the CM 21 (storage apparatus 20) according to the second embodiment may be implemented. The storage control apparatus 1 according to the first embodiment may also be implemented by similar hardware to that of the CM 21.

The CM 21 implements the processing functions according to the second embodiment by, for example, executing a program recorded on a computer-readable recording medium. The program in which contents of the processing to be performed by the CM 21 are described may be recorded on various storage media. For example, the program to be executed by the CM 21 may be stored in a nonvolatile memory. The processor 23 loads at least part of the program stored in the nonvolatile memory onto the memory 24 and executes the program. The program to be executed by the CM 21 may be stored in a portable storage medium (not illustrated), such as an optical disk, a memory device, and a memory card. Examples of the optical disk include, for example, a digital versatile disc (DVD), a DVD-RAM, a compact disc read-only memory (CD-ROM), and a CD recordable/rewritable (CD-R/RW). The memory device is a storage medium equipped with a functionality of communicating with an input/output interface or an equipment connection interface (not illustrated). For example, the memory device may perform writing data into the memory card or reading data from the memory card by a memory reader/writer. The memory card is a card type storage medium.

The program stored in the portable storage medium becomes executable after being installed into the nonvolatile memory under control of the processor 23, for example. The processor 23 may directly read the program from the portable storage medium to execute the program.

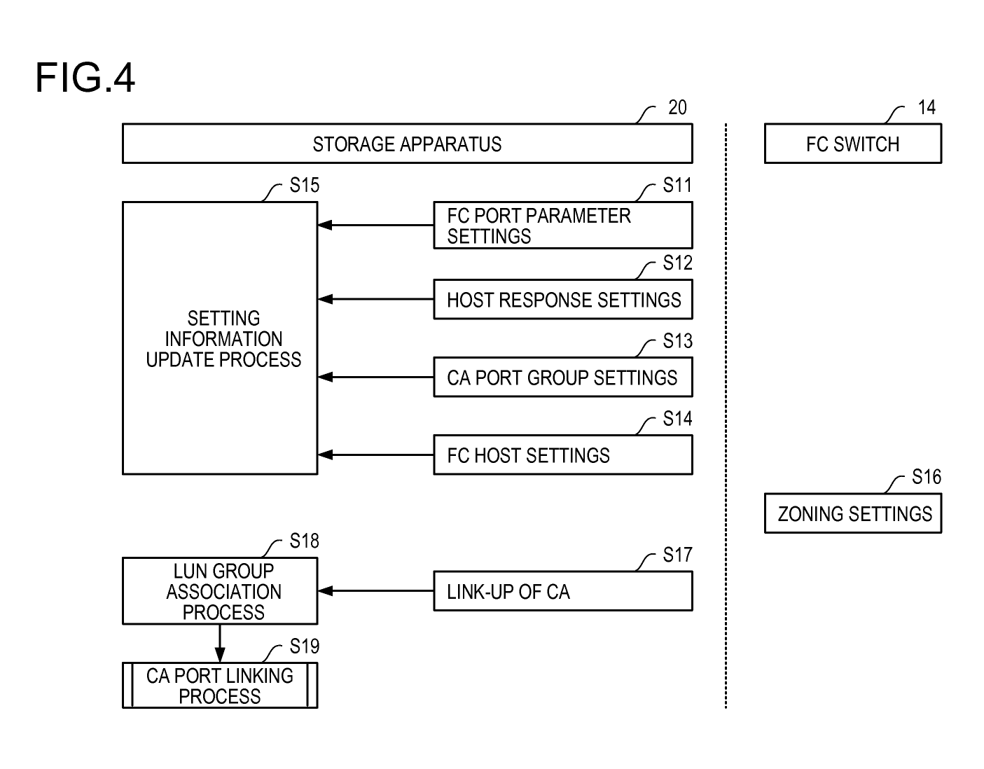

Next, descriptions will be given on a procedure sequence of connection between the host and the storage apparatus in the storage system according to the second embodiment with reference to FIG. 4 through FIG. 11. First, descriptions will be given on an operational procedure in the storage apparatus and in the FC switch at the time of new introduction with reference to FIG. 4. FIG. 4 is a diagram illustrating an example of operational procedure in the storage apparatus and the FC switch at the time of new introduction according to the second embodiment.

The storage apparatus 20 is able to recognize the WWPN of the host 11, but is not able to directly recognize and identify the host 11. Therefore, an administrator of the storage system 10 performs a connection operation for connecting the host 11 with the storage apparatus 20 at the time of new introduction where the host 11 is newly connected to the storage apparatus 20. In the operation for connecting the host 11 with the storage apparatus 20, the administrator sets up various information, such as, information indicating the correspondence between the host 11 including the cluster 13 and the WWPN or information indicating the correspondence between the host 11 and the LUN.

Hereinafter, an example of a specific operational procedure will be described.

The storage apparatus 20 receives FC port parameter settings as input (S11). The input operation of the FC port parameter settings is performed by, for example, the administrator of the storage system 10. The FC port parameter settings include settings regarding a connection type of the port 22 and settings regarding a transfer speed.

The storage apparatus 20 receives host response settings as input (S12). The input operation of the host response settings is performed by, for example, the administrator of the storage system 10. The host response settings include settings regarding a style of a response to an I/O request received from the host 11. The host response settings include, for example, a default setting determined in accordance with the type of OS equipped in the host 11 or a newly prepared setting.

The storage apparatus 20 receives CA port group settings as input (S13). The input operation of the CA port group settings is performed by, for example, the administrator of the storage system 10. The CA port group settings include settings for grouping the ports 22 depending on a connection destination.

The storage apparatus 20 receives FC host settings as input (S14). The input operation of the FC host settings is performed by, for example, the administrator of the storage system 10. When performing the input operation, the administrator confirms the correspondence between the host 11 to be connected and the WWPN. The FC host settings include settings for allocating the host response settings inputted to be set at S12 and the FC port group settings for grouping the ports 12 depending on a connection destination.

The storage apparatus 20 performs a setting information update process (S15). The setting information update process is a process for updating the setting information in accordance with the inputted FC port parameter settings, the inputted host response settings, the inputted CA port group settings, and the inputted FC host settings.

The storage apparatus 20 may perform the setting information update process each time when each of the FC port parameter settings, the host response settings, the CA port group settings, and the FC host settings are inputted.

The FC switch 14 receives zoning settings as input and updates the zoning settings (S16). The input operation of the zoning settings is performed by, for example, the administrator of the storage system 10. The zoning settings include, for example, a world wide name (WWN) zoning settings.

The storage apparatus 20 detects a link-up of the channel adapter 26 (S17). The link-up of the channel adapter 26 is performed, for example, in response to manipulation by the administrator of the storage system 10.

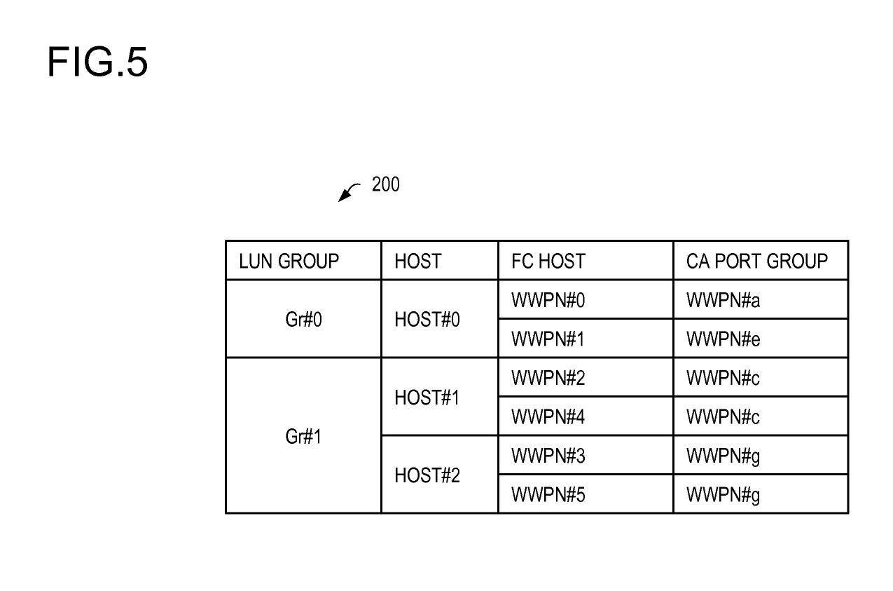

The storage apparatus 20 associates a LUN group, a CA port group, and an FC host with one another upon the detection of the link-up of the channel adapter 26 (S18). The setting information updated at S15 may be used as information to be used for the association. The LUN group, the CA port group, and the FC host is managed in association with one another in a LUN group association information table. The LUN group association information table will be described later with reference to FIG. 5.

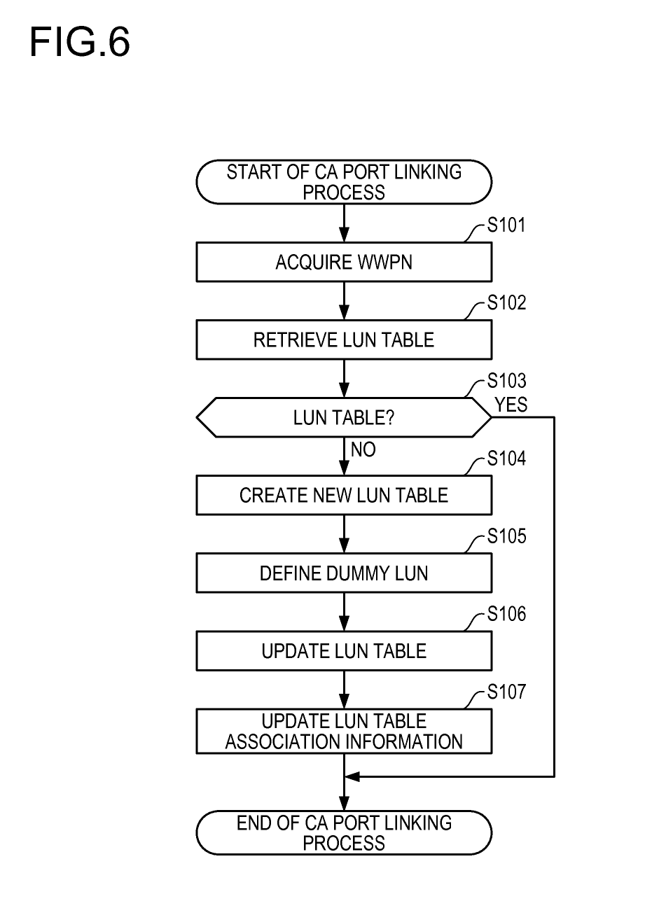

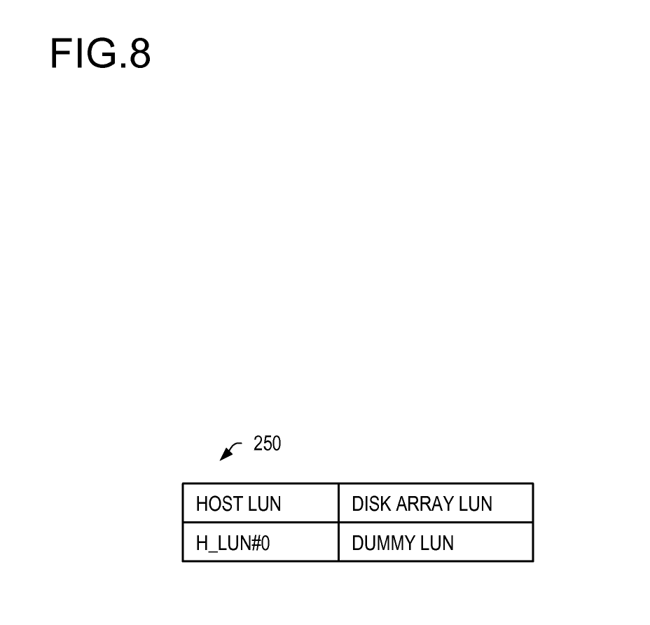

The storage apparatus 20 performs a CA port linking process (S19). The CA port linking process is a process of creating and updating the LUN table and associating the LUN group with the LUN table. The LUN table, which corresponds to the management information 5 according to the first embodiment, is a table holding management information for managing accessible LUNs for each LUN group. The LUN table will be described later with reference to FIG. 8. Details of the CA port linking process will be described later with reference to FIG. 6.

Here, the LUN group association information table will be described with reference to FIG. 5. FIG. 5 is a diagram illustrating an example of a LUN group association information table according to the second embodiment. A LUN group association information table 200 holds the setting information to be updated in the setting information update process by the storage apparatus 20. The LUN group association information table 200 is stored in the memory 24, for example.

Each entry of the LUN group association information table 200 includes items for “LUN group”, “host”, “FC host”, and “CA port group”. The item “LUN group” is information for uniquely identifying, in the storage system 10, a group of hosts 11 accessible to the same LUN. The item “LUN group” is, for example, Gr#0 and Gr#1. The item “host” is information for uniquely identifying, in the storage system 10, a host 11 included in the LUN group. The LUN group association information table 200 indicates that the host#0 is included in the Gr#0, and the host#1 and the host#2 are included in the Gr#1.

The item “FC host” is information for uniquely identifying the port 12 in the storage system 10. For example, the item “FC host” is the WWPN of the port 12. The item “CA port group” is information for uniquely identifying the port 22 in the storage system 10. For example, the item “CA port group” is the WWPN of the port 22.

As described above, the LUN group association information table 200 associates a single LUN group with one or more ports 12 and one or more ports 22. Further, the LUN group association information table 200 associates the port 12 with the port 22.

The item “CA port group” may include a sub-item “CM” and a sub-item “CM port” and uniquely identify the port 22 by a combination of the sub-item “CM” and the sub-item “CM port”. The sub-item “CM” is information for uniquely identifying the CM 21 in the storage system 10. The sub-item “CA port” is information for uniquely identifying the port 22 in the CM 21.

Next, the CA port linking process will be described with reference to FIG. 6. FIG. 6 is a flowchart of the CA port linking process according to the second embodiment. The storage apparatus 20 performs the CA port linking process in response to the link-up of the channel adapter 26 at S17 in the operational procedure at the time of new introduction illustrated in FIG. 4.

The storage apparatus 20 acquires the WWPN of the port 22 (CA port) at which the link-up of the channel adapter 26 is detected (S101). The storage apparatus 20 retrieves the LUN table associated with the WWPN (S102).

The storage apparatus 20 determines whether the LUN table associated with the WWPN is present (S103). When it is determined that the LUN table associated with the WWPN is not present, the process proceeds to S104. When it is determined that the LUN table associated with the WWPN is present, the storage apparatus 20 ends the CA port linking process.

The storage apparatus 20 creates a new LUN table (S104). The storage apparatus 20 defines a dummy LUN, which corresponds to the first logical volume 6a according to the first embodiment (S105).

The storage apparatus 20 updates the newly created LUN table by reflecting the defined dummy LUN (S106). The storage apparatus 20 updates the LUN table association information (S107), and ends the CA port linking process.

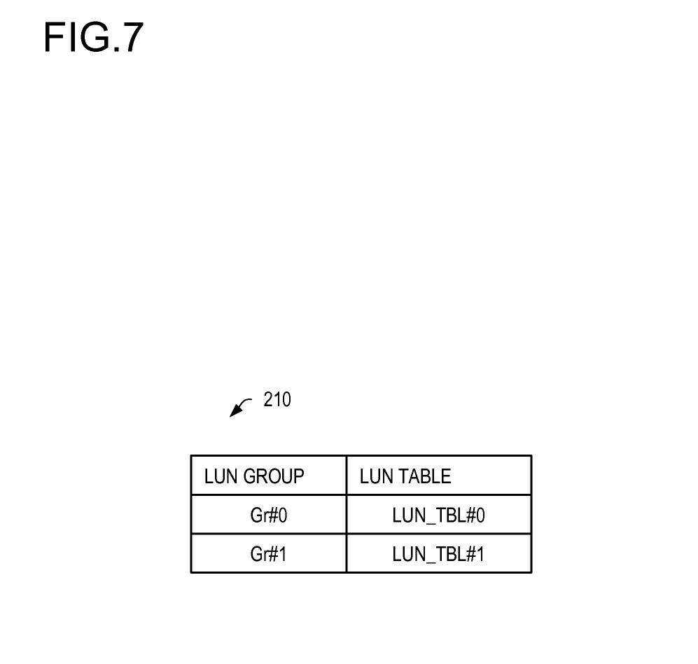

Here, the LUN table association information will be described with reference to FIG. 7. FIG. 7 is a diagram illustrating an example of the LUN table association information according to the second embodiment. A LUN table association information 210 holds information indicating a correspondence between a LUN group and a LUN table associated with the LUN group. The LUN table association information 210 is stored in the memory 24, for example.

Each entry of the LUN table association information 210 includes an item “LUN group” and an item “LUN table”. The item “LUN group” is the identification information for uniquely identifying a LUN group. The item “LUN table” is identification information for uniquely identifying a LUN table. The item “LUN table” is, for example, LUN_TBL#0 and LUN_TBL#1. The LUN table association information 210 holds association information about a LUN group of Gr#0 and association information about a LUN group of Gr#1. The LUN table association information 210 indicates that the LUN group of Gr#0 is associated with a LUN table of LUN_TBL#0. Further, the LUN table association information 210 indicates that the LUN group of Gr#1 is associated with a LUN table of LUN_TBL#1. The LUN_TBL#0 and LUN_TBL#1 are identification information for uniquely identifying the LUN table.

As described above, the storage apparatus 20 may hold the information which indicates a correspondence between a LUN group and a LUN table associated with the LUN group so as to manage the LUN for each LUN group. Further, the storage apparatus 20 may associate setting information for each LUN group with a LUN table. Accordingly, the storage apparatus 20 does not perform the setting up each time a dummy LUN to be included in the LUN table is created.

Next, descriptions will be given on the LUN table with reference to FIG. 8. FIG. 8 is a diagram illustrating an example of a newly created LUN table according to the second embodiment. A LUN table 250 holds management information for managing accessible LUNs for each LUN group. The LUN table 250 is stored in the memory 24, for example.

The LUN table 250 may be identified by identification information for uniquely identifying the LUN table. For example, the LUN table 250 has “LUN_TBL#0” as its identification information. Thus, the LUN table 250 is identified as a LUN table for the LUN group of Gr#0 by referring to the LUN table association information 210.

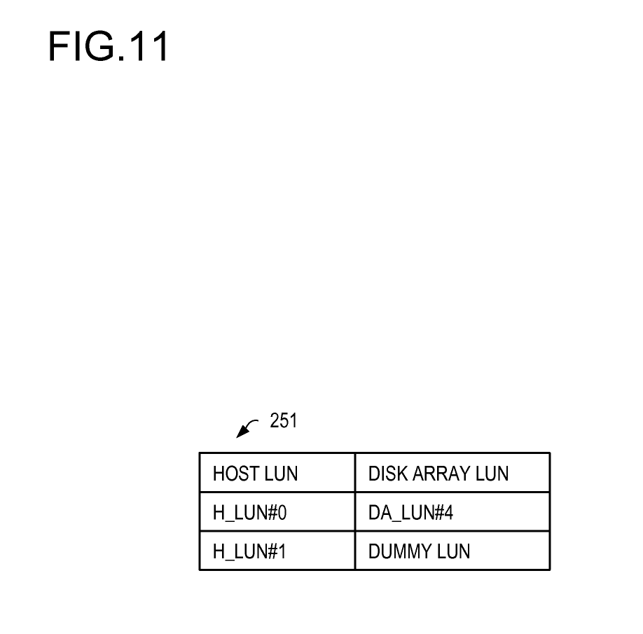

Each entry of the LUN table 250 includes an item “host LUN” and an item “disk array LUN”. The item “host LUN” is identification information for uniquely identifying the LUN by the host 11 included in the LUN group. The item “host LUN” is H_LUN#0, for example. The item “disk array LUN” is identification information for uniquely identifying the LUN by the disk array 30. The item “disk array LUN” may be “dummy LUN”. Since a dummy LUN does not have a storage resource allocated thereto, the dummy LUN does not have identification information as an exception but has information indicating that the LUN is a dummy. A specific example of the item “disk array LUN” will be described later with reference to FIG. 11.

The LUN table 250 indicates a LUN table which is newly created at S104, for which a dummy LUN is defined at S105, and which is updated by reflecting the defined dummy LUN at S106 in the CA port linking process.

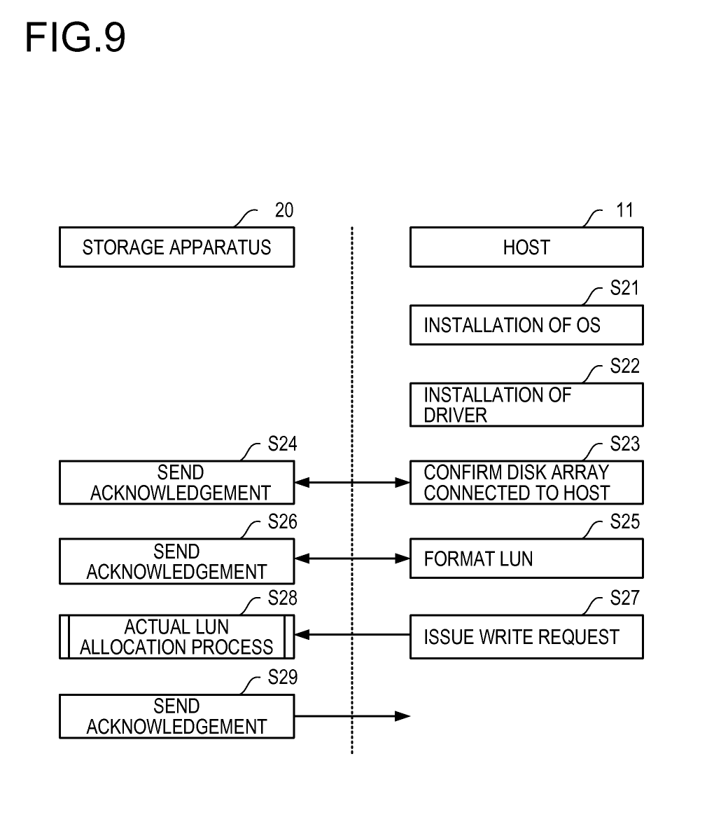

Next, descriptions will be given on the operational procedure in the storage apparatus and in the host at the time of new introduction. FIG. 9 is a diagram illustrating an example of operational procedure in the storage apparatus and in the host at the time of new introduction according to the second embodiment.

The operational procedure in the storage apparatus and in the host at the time of new introduction is performed after the operational procedure in the storage apparatus and in the FC switch at the time of new introduction, which is described with reference to FIG. 4. Hereinafter, a specific example of the operational procedure will be described.

Installation of an OS is performed in the host 11 (S21). The installation operation of the OS is performed by, for example, the administrator of the storage system 10. The installation of the OS includes installation of, for example, a service pack (SP) patch file in addition to the OS.

Installation of drivers is performed in the host 11 (S22). The installation operation of the drivers is performed by, for example, the administrator of the storage system 10. The installation of the drivers is not limited to installation of drivers in the narrow sense such as, for example, installation of an FC card driver, but may include construction of a multipath environment/a single path environment.

The host 11 performs confirmation of the disk array 30 connected to the host 11 (S23). For example, the host 11 performs a reboot of the host 11 and a rescan of the disk upon receipt of instruction from the administrator of the storage system 10 after the power source is turned ON for the host 11, the FC switch 14, and the disk array 30.

The storage apparatus 20 sends an acknowledgement in response to the rescan of the disk by the host 11 (S24). For example, the storage apparatus 20 sends a response with the LUN recognized as a result of the rescan. Normally, the storage apparatus 20 sends a response with a dummy LUN, to the host 11 which is newly connected. For example, the storage apparatus 20 refers to the LUN table 250 to send the H_LUN#0, which is a dummy LUN, to the host.

The host 11 receives a request for formatting the dummy LUN and instructs the storage apparatus 20 to perform the formatting of the dummy LUN (S25). The formatting of the dummy LUN is requested by, for example, a user of the host 11.

The storage apparatus 20 receives the instruction and performs the formatting of the dummy LUN. The storage apparatus 20 sends an acknowledgement to the host 11 after performing the formatting of the dummy LUN (S26). The formatting of the dummy LUN includes, for example, writing required information (meta-data used in a file system, for example) into a meta-data area of the dummy LUN.

The host 11 receives a request for writing to the dummy LUN and issues a write request for the dummy LUN to the storage apparatus 20 (S27). The writing to the dummy LUN is requested by, for example, the user of the host 11.

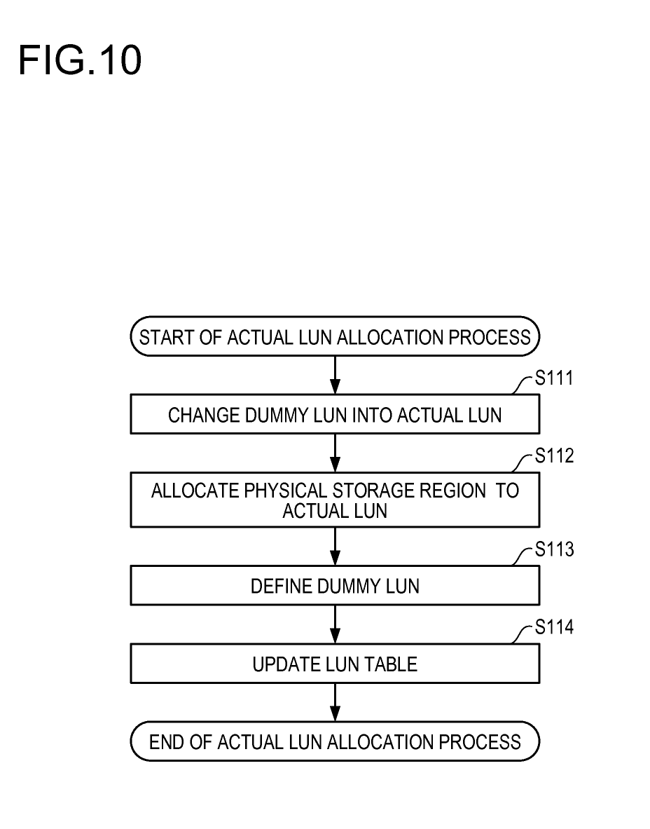

The storage apparatus 20 performs an actual LUN allocation process (S28). The actual LUN allocation process is a process for allocating a storage resource to a dummy LUN to change the dummy LUN to an actual LUN which is a LUN allocated with a storage resource. The actual LUN corresponds to the second logical volume 6b according to the first embodiment. Details of the actual LUN allocation process will be described later with reference to FIG. 10.

The storage apparatus 20 sends an acknowledgement to the host 11 after performing the writing in response to the write request (S29). The formatting of the dummy LUN at S25 and the issuance of the write request for the dummy LUN at S27 may be performed later instead of being included in the operational procedure at the time of new introduction. The formatting of the dummy LUN and the issuance of the write request for the dummy LUN may be suitably performed when the user uses the LUN.

Next, descriptions will be given on the actual LUN allocation process with reference to FIG. 10. FIG. 10 is a flowchart of the actual LUN allocation process according to the second embodiment. The storage apparatus 20 performs the actual LUN allocation process upon receipt of the write request at S28 in the operational procedure at the time of new introduction.

The storage apparatus 20 assigns identification information as a disk array LUN to the dummy LUN to change the dummy LUN into an actual LUN (S111). The storage apparatus 20 allocates a storage resource to the actual LUN changed from the dummy LUN (S112). The storage apparatus 20 allocates, in accordance with a size of write data, segment units (one unit, for example) of the physical storage region to the actual LUN changed from the dummy LUN.

The storage apparatus 20 defines a new dummy LUN (S113). For example, the storage apparatus 20 defines a dummy LUN having identification information (the smallest number, for example) unused by host LUNs included in the LUN table.

The storage apparatus 20 updates the LUN table by reflecting the defined dummy LUN (S114), and ends the actual LUN allocation process.

Next, descriptions will be given on the LUN table after the actual LUN allocation process is ended with reference to FIG. 11. FIG. 11 is a diagram illustrating an example of a LUN table after the actual LUN allocation process according to the second embodiment is ended. A LUN table 251 is a LUN table obtained by updating the newly prepared LUN table 250. Accordingly, identification information of the LUN table 251 is LUN_TBL#0 which is the same as that of the LUN table 250.

In the LUN table 251, the item “host LUN” is H_LUN#0 and H_LUN#1 and the item “disk array LUN” is DA_LUN#4 and “dummy LUN”. The H_LUN#0 corresponds to the DA_LUN#4 and the H_LUN#1 corresponds to “dummy LUN”.

That is, the H_LUN#0 which has been the dummy LUN in the LUN table 250 becomes, in response to the write request, an actual LUN having identification information DA_LUN#4 which is identification information as a disk array LUN. The dummy LUN in the LUN table 250 is changed to an actual LUN, and the LUN table 250 has no dummy LUN. Therefore, a new dummy LUN is defined as described at S113 of the actual LUN allocation process and a new entry for the newly defined dummy LUN is added. The newly defined dummy LUN is H_LUN#1.

The H_LUN#1 may be also changed to an actual LUN in response to a write request, similarly as for the H_LUN#0. Conventionally, since such an operation of adding a LUN requires more complicated operation and performed by, for example, an administrator. Thus a burden of work load on the administrator has been excessive. Further, the user has not always been able to perform the addition of a LUN at an appropriate timing. The storage apparatus 20 according to the present embodiment may add a LUN in response to a write request issued by the user of the host 11. Accordingly, the storage apparatus 20 may reduce a burden of work load on the administrator or the like. Further, the storage apparatus 20 may provide an appropriate use environment to the user, in which a LUN may be added at an appropriate timing.

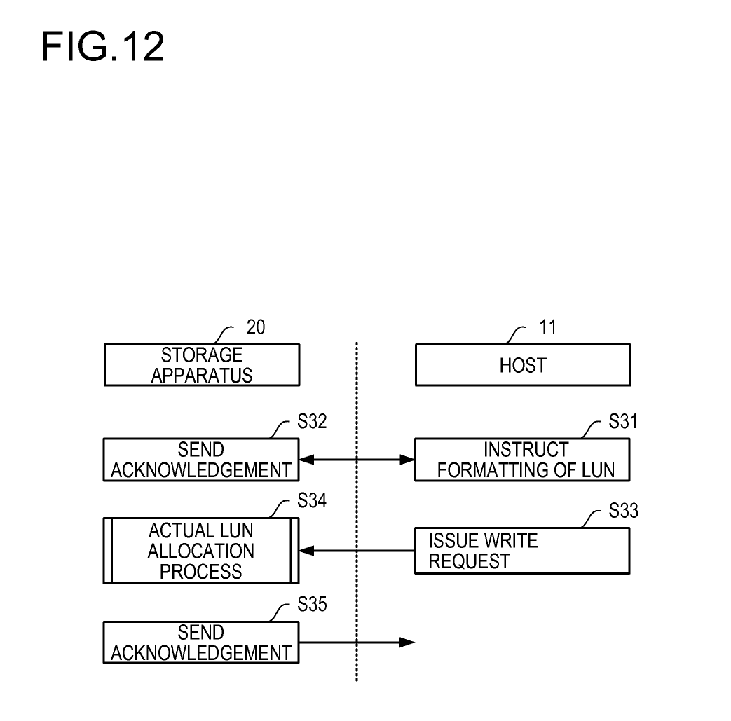

Next, descriptions will be given on an operational procedure in the storage apparatus and in the host at the time of addition of a LUN with reference to FIG. 12. FIG. 12 is a diagram illustrating an example of an operational procedure in the storage apparatus and in the FC switch at the time of addition of a LUN according to the second embodiment.

Hereinafter, an example of a specific operational procedure will be described.

The host 11 receives a request for formatting the dummy LUN and instructs the storage apparatus 20 to perform the formatting of the dummy LUN (S31).

The storage apparatus 20 receives the instruction and performs the formatting of the dummy LUN. The storage apparatus 20 sends an acknowledgement to the host 11 after performing the formatting of the dummy LUN (S32).

The host 11 receives a request for writing to the dummy LUN and issues a write request for the dummy LUN to the storage apparatus 20 (S33). The storage apparatus 20 performs the actual LUN allocation process (S34).

The storage apparatus 20 sends an acknowledgement to the host 11 after performing the writing in response to the write request (S35). The formatting of the dummy LUN at S31 and the issuance of the write request for the dummy LUN at S33 may be suitably performed when the user uses the LUN.

As described above, the storage apparatus 20 may perform addition of a LUN without performing the setting up of the LUN group. Further, the storage apparatus 20 may exclude an erroneous setting for the addition of a LUN. Accordingly, the storage apparatus 20 may provide an appropriate use environment to the user in addition to reducing the burden of work load on the administrator or the like.

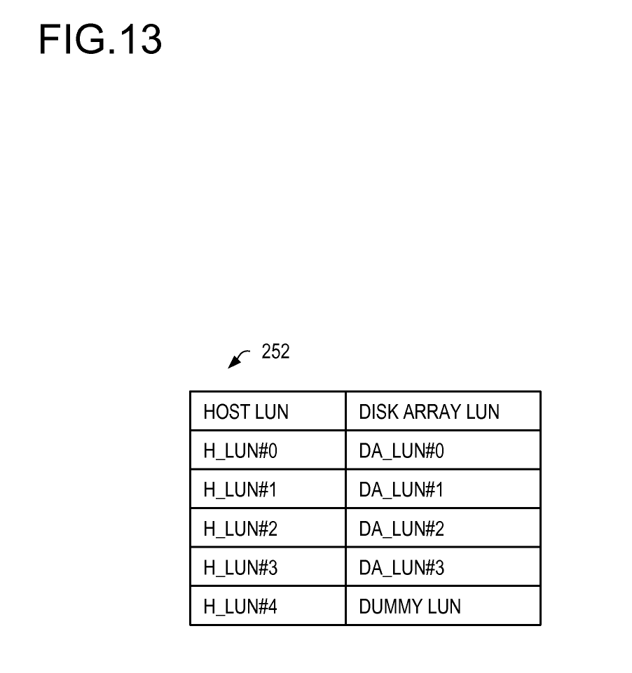

Next, descriptions will be given on another example of the LUN table with reference to FIG. 13. FIG. 13 is a diagram illustrating an example of a LUN table for a LUN group which is different from a LUN group of the LUN table illustrated in FIG. 11. A LUN table 252 is a LUN table for a LUN group Gr#1 which is different from the LUN group Gr#0 of the LUN table 250 and the LUN table 251. Identification information of the LUN table 252 is LUN_TBL#1.

In the LUN table 252, the item “host LUN” is H_LUN#0, H_LUN#1, H_LUN#2, H_LUN#3, and H_LUN#4. Further, in the LUN table 252, the item “disk array LUN” is DA_LUN#0, DA_LUN#1, DA_LUN#2, DA_LUN#3, and “dummy LUN”.

The item “host LUN” may include identification information (H_LUN#0, H_LUN#1, for example) which overlaps with that in the LUN table 251, but when uniqueness for each LUN group is guaranteed, the overlap between the LUN groups is permitted. Since the item “disk array LUN” has uniqueness in the disk array, the item “disk array LUN” does not overlap between the LUN groups.

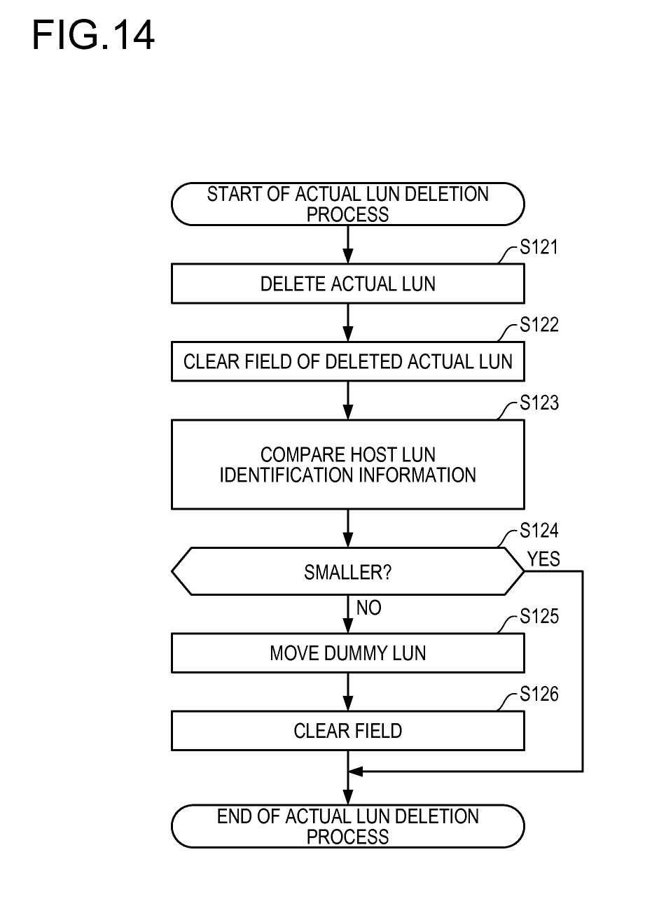

Next, descriptions will be given on an actual LUN deletion process with reference to FIG. 14. FIG. 14 is a flowchart of the actual LUN deletion process according to the second embodiment. The actual LUN deletion process is a process for deleting an actual LUN. The actual LUN deletion process is performed by the storage apparatus 20 upon receipt of the instruction to delete an actual LUN.

The storage apparatus 20 deletes an actual LUN for which the instruction to delete is made (S121). The deletion of the actual LUN is performed by releasing the storage resource which has been allocated to the LUN. The storage apparatus 20 clears a field of the deleted actual LUN from the LUN table (S122). The clearing of the field of the actual LUN includes clearing the item “disk array LUN” associated with the deleted actual LUN.

The storage apparatus 20 compares, in the LUN table, the identification information of the item “host LUN” corresponding to the deleted actual LUN with the identification information of the item “host LUN” corresponding to the dummy LUN (S123).

When the identification information of the item “host LUN” corresponding to the dummy LUN is smaller than the identification information of the item “host LUN” corresponding to the deleted actual LUN (YES at S124), the storage apparatus 20 ends the actual LUN deletion process. When the identification information of the item “host LUN” corresponding to the dummy LUN is not smaller than the identification information of the item “host LUN” corresponding to the deleted actual LUN, the process proceeds to S125. When the identification information is other than numerical information, sorting orders obtained by sorting the identification information in accordance with a predetermined criterion may be compared to determine the relationship between the identification information as to which one is larger or smaller.

The storage apparatus 20 moves the dummy LUN to a location of the deleted actual LUN in the LUN table (S125). That is, the storage apparatus 20 replaces the identification information of the item “host LUN” corresponding to the dummy LUN with the identification information of the item “host LUN” of the deleted actual LUN.

The storage apparatus 20 clears a field of a movement source of the dummy LUN in the LUN table (S126). That is, the storage apparatus 20 clears information regarding the correspondence between the identification information of the item “host LUN” corresponding to the dummy LUN before the update and the item “disk array LUN”. The storage apparatus 20 ends the actual LUN deletion process after clearing the field of the movement source of the dummy LUN.

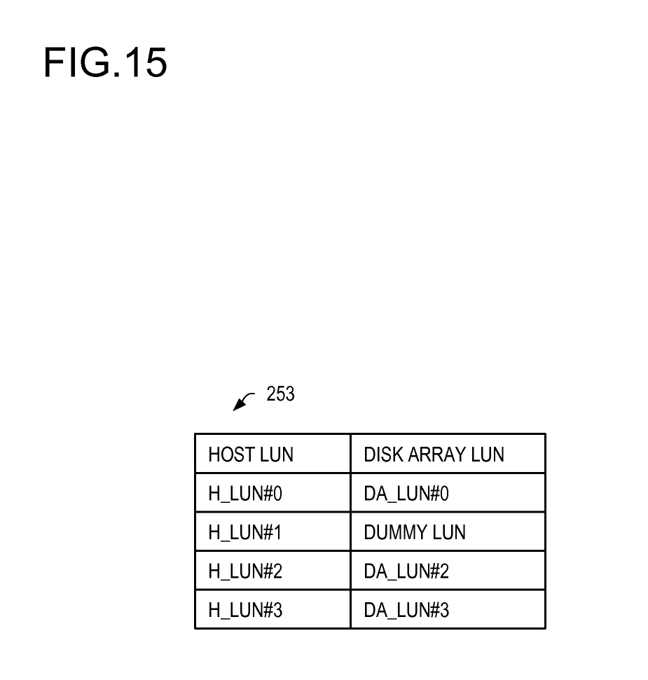

Here, descriptions will be given on a LUN table after the actual LUN deletion process is ended with reference to FIG. 15. FIG. 15 is a diagram illustrating an example of a LUN table after the actual LUN deletion process according to the second embodiment is ended. A LUN table 253 is a LUN table obtained by deleting the actual LUN of the H_LUN#1 from the LUN table 252. Accordingly, the identification information of the LUN table 253 is LUN_TBL#1 which is the same as that of the LUN table 252.

In the LUN table 252, the actual LUN corresponding to the H_LUN#1 is deleted to cause the DA_LUN#1 of the item “disk array LUN” to be cleared. The dummy LUN moves to the entry of the H_LUN#1 where the item “disk array LUN” is cleared and the entry of the H_LUN#4 where the dummy LUN is originally included is cleared. In this manner, the LUN table 252 is updated to obtain the LUN table 253.

As described above, the storage apparatus 20 may readily perform a deletion operation of a LUN. Accordingly, the storage apparatus 20 may provide an appropriate use environment to, for example, the user, in addition to reducing the burden of work load on the administrator or the like.

### Third Embodiment

Next, descriptions will be given on a third embodiment. The third embodiment is different from the second embodiment in that two or more LUN tables are allocated to a single host. The similar reference numerals are assigned to the constitutional elements which are similar to those according to the second embodiment, and descriptions thereof will be omitted.

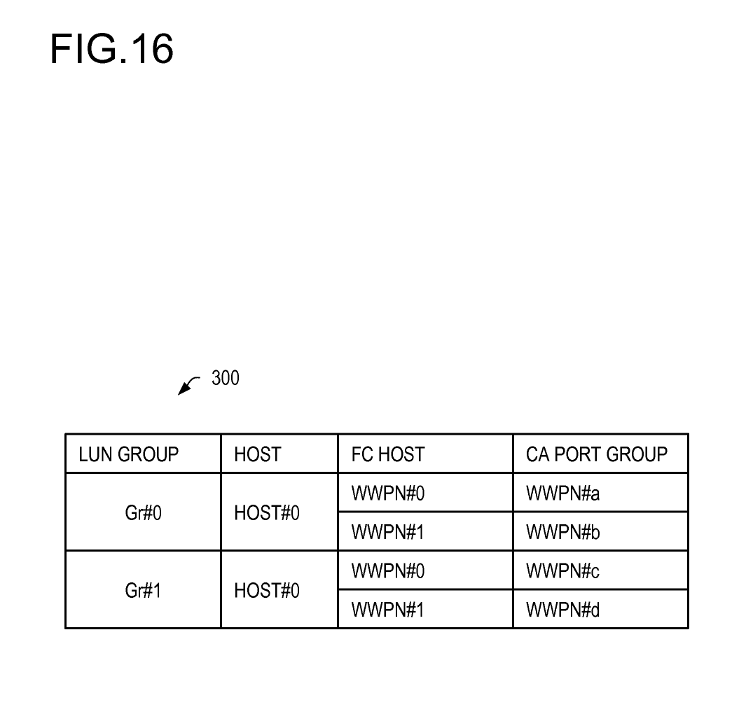

First of all, descriptions will be given on an example of the LUN group association information table with reference to FIG. 16. FIG. 16 is a diagram illustrating an example of a LUN group association information table according to a third embodiment. A LUN group association information table 300 holds the setting information to be updated in the setting information update process by the storage apparatus 20. The LUN group association information table 300 is stored in the memory 24, for example.

The LUN group association information table 300 includes items for “LUN group”, “host”, “FC host”, and “CA port group”. The item “LUN group” is information for uniquely identifying, in the storage system 10, a group of hosts 11 capable of accessing the same LUN. The item “LUN group” is, for example, Gr#0 and Gr#1. The item “host” is information for uniquely identifying, in the storage system 10, a host 11 included in the LUN group. The LUN group association information table 300 indicates that the host#0 is included in the Gr#0 and the Gr#1.

The item “FC host” is information for uniquely identifying the port 12 in the storage system 10. For example, the item “FC host” is the WWPN of the port 12. The item “CA port group” is information for uniquely identifying the port 22 in the storage system 10. For example, the item “CA port group” is the WWPN of the port 22.

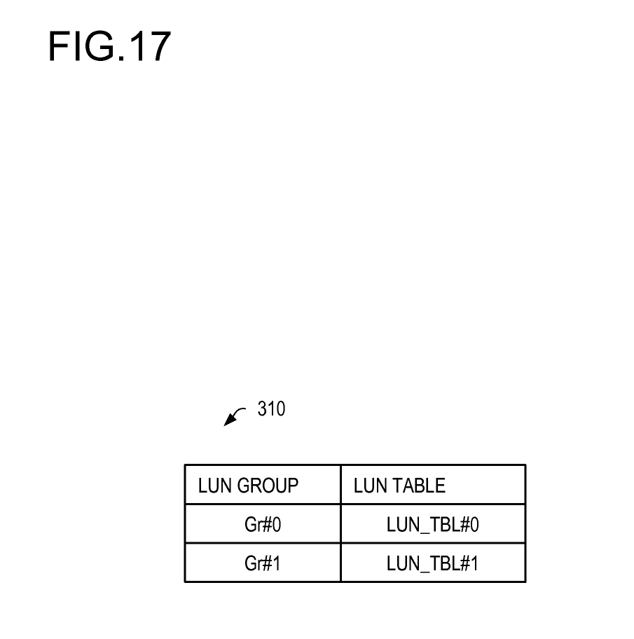

Next, the LUN table association information will be described with reference to FIG. 17. FIG. 17 is a diagram illustrating an example of LUN table association information according to the third embodiment. A LUN table association information 310 holds information indicating a correspondence between a LUN group and a LUN table associated with the LUN group. The LUN table association information 310 is stored in, for example, the memory 24.

The LUN table association information 310 holds association information related to the LUN group of Gr#0 and association information related to the LUN group of Gr#1. The LUN table association information 310 indicates that the LUN group of Gr#0 is associated with a LUN table of LUN_TBL#0. Further, the LUN table association information 310 indicates that the LUN group Gr#1 is associated with a LUN table of LUN_TBL#1. Each of the LUN_TBL#0 and the LUN_TBL#1 is identification information for uniquely identifying a LUN table.

In this manner, even when two or more LUN tables are allocated for the host 11, the storage apparatus 20 may identify the LUN groups associated with the LUN tables.

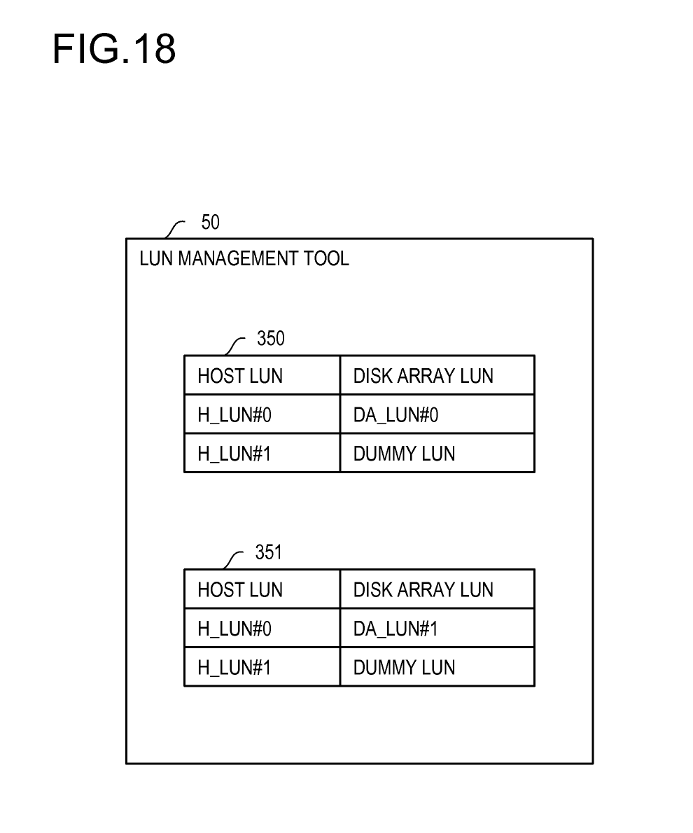

The host 11 is provided with a LUN management tool in order to make it possible to determine which LUN table the dummy LUN is included in when two or more dummy LUNs are present. Descriptions will be given on a LUN management tool of a third embodiment with reference to FIG. 18. FIG. 18 is a diagram illustrating an example of a LUN management tool according to the third embodiment.

A LUN management tool 50 runs under the OS of the host 11. The LUN management tool 50 allows selection of a dummy LUN to be recognized by the user on the host 11. The LUN management tool 50 acquires the LUN table managed by the storage apparatus 20 and sets a dummy LUN to be recognized by the user on the host 11. For example, the LUN management tool 50 acquires a LUN table 350 and a LUN table 351 from the storage apparatus 20. The LUN management tool 50 sets a dummy LUN of the LUN table 350 or a dummy LUN of the LUN table 351 as the dummy LUN to be recognized by the user. For example, the LUN management tool 50 receives an instruction from the administrator of the host 11 to set the dummy LUN to be recognized by the user.

In this manner, the user may change the dummy LUN in the LUN table, which is set by the LUN management tool 50, into an actual LUN. The LUN management tool 50 may uniquely identify a LUN on the basis of the identification information of the LUN table and the identification information of the host LUN even when the host LUN is redundant between the LUN table 350 and the LUN table 351.

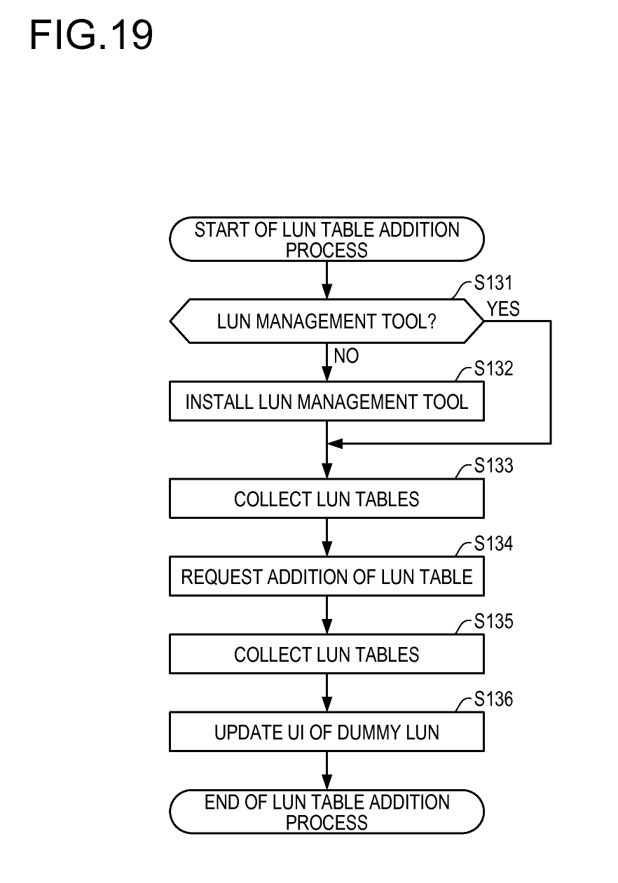

Next, descriptions will be given on a LUN table addition process performed by the host 11 with reference to FIG. 19. FIG. 19 is a flowchart of the LUN table addition process according to the third embodiment. The LUN table addition process is a process for adding a LUN table by using the LUN management tool 50. The host 11 receives a manipulation of adding the LUN table from the user and performs the LUN table addition process.

The host 11 determines whether the host 11 includes the LUN management tool 50 or not (S131). When it is determined that the host 11 includes the LUN management tool 50, the process proceeds to S133. When it is determined that the host 11 does not include the LUN management tool 50, the process proceeds to S132.

The host 11 installs the LUN management tool 50 in the host 11 (S132). The host 11 activates the LUN management tool 50 to collect the LUN tables from the storage apparatus 20 (S133).

The host 11 requests the storage apparatus 20 to add a LUN table (S134). The host 11 specifies other hosts to be included in the LUN group if any.

The storage apparatus 20 receives the request, creates the LUN group and the LUN table, and associates the LUN group with the LUN table. In this time, the storage apparatus 20 may refer to the information already set in a previously created (established) LUN table so that the settings are inherited by the new LUN table. Accordingly, when an existing user adds a LUN table, the storage apparatus 20 performs the addition without an operation of setting by the administrator of the storage system 10.

The host 11 collects the LUN tables after the addition from the storage apparatus 20 (S135). The host 11 sets, by using the LUN management tool 50, the dummy LUN to be recognized by the user (S136). The host 11 updates a user interface (UI) of the dummy LUN with settings of the dummy LUN to be recognized by the user. Specifically, the dummy LUN set by the LUN management tool 50 is displayed and the dummy LUN which is not set by the LUN management tool 50 is not displayed. The host 11 terminates the LUN management tool 50 and ends the LUN table addition process.

With the LUN table added as described above, the dummy LUN to be recognized by the user may be set for each host 11 even when the LUN group includes other hosts 11. Since the setting for each host 11 does not influence on the LUN table managed by the storage apparatus 20, the processing performed by the storage apparatus 20 is not complicated.

The host 11 is configured to switch the dummy LUN to be recognized by the user by the LUN management tool 50, between two aspects of displayed and non-displayed, but is not limited thereto. The host 11 may be configured to change the aspects of displaying for each LUN group such that the LUN group including the dummy LUN is to be recognized by the user.

The processing functions described above may be implemented by a computer. In this case, a program is provided in which processing contents of functions to be equipped in, for example, the storage control apparatus 1, the storage apparatus 20, the CM 21, or the host 11 are written. When the program is executed by the computer, the processing functions are implemented on the computer. The program in which the processing contents are written may be recorded in a computer-readable recording medium. Examples of the computer-readable recording medium include, for example, a magnetic storage device, an optical disk, an opto-magnetic storage medium, and a semiconductor memory. Examples of the magnetic storage device include, for example, an HDD, a flexible disk (FD), and a magnetic tape. Examples of the optical disk include, for example, a DVD, a DVD-RAM, and a CD-ROM/RW. Examples of the opto-magnetic storage medium include, for example, a magneto-optical disk (MO).

When it is intended to distribute the program, for example, a portable storage medium such as a DVD or a CD-ROM, in which the program is recorded is sold. Further, the program may be stored in a storage device of a server computer and then the program may be transferred from the server computer to other computer through a network.

The computer which executes the program stores, for example, the program recorded in the portable storage medium or the program transferred from the server computer in the storage device of its own. The computer reads the program from the storage device of its own and executes the processing in accordance with the program. The computer may read a program directly from the portable storage medium and execute the processing in accordance with the program. The computer may sequentially execute the processing in accordance with a received program each time when the program is transferred from the server computer connected through the network.

At least a portion of the processing functions described above may be implemented by an electronic circuit, such as a DSP, an ASIC, or a PLD.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a illustrating of the superiority and inferiority of the invention. Although the embodiments of the present invention have been described in detail, it should be understood that the various changes, substitutions, and alterations could be made hereto without departing from the spirit and scope of the invention.

What is claimed is:

1. A storage control apparatus, comprising:
a processor configured to
create management information upon detecting a connection with an information processing apparatus,
set a first logical volume for the information processing apparatus in the management information, the first logical volume being allocated with no physical storage region,
convert, upon receiving a write request for the first logical volume from the information processing apparatus, the first logical volume into a second logical volume by allocating a physical storage region to the first logical volume, and
set the second logical volume in the management information.

2. The storage control apparatus according to claim 1, wherein
the processor is configured to
detect the connection by detecting a link-up with the information processing apparatus.

3. The storage control apparatus according to claim 1, wherein
the processor is configured to
set a third logical volume in the management information after the conversion, the third logical volume being allocated with no physical storage region.

4. The storage control apparatus according to claim 2, wherein
the management information includes setting information used for the link-up.

5. The storage control apparatus according to claim 1, wherein
the processor is configured to
acquire identification information of the information processing apparatus, and
determine, based on the identification information, whether to create the management information.

6. The storage control apparatus according to claim 1, wherein
the processor is configured to
perform the conversion by allocating a first number of segment units of the physical storage region to the first logical volume, the first number corresponding to a size of write data specified in the write request.

7. A computer-readable recording medium having stored therein a program for causing a computer to execute a process, the process comprising:
creating management information upon detecting a connection with an information processing apparatus;
setting a first logical volume for the information processing apparatus in the management information, the first logical volume being allocated with no physical storage region;
converting, upon receiving a write request for the first logical volume from the information processing apparatus, the first logical volume into a second logical volume by allocating a physical storage region to the first logical volume; and
setting the second logical volume in the management information.

8. A storage control method, comprising:
creating, by a computer, management information upon detecting a connection with an information processing apparatus;
setting a first logical volume for the information processing apparatus in the management information, the first logical volume being allocated with no physical storage region;
converting, upon receiving a write request for the first logical volume from the information processing apparatus, the first logical volume into a second logical volume by allocating a physical storage region to the first logical volume; and
setting the second logical volume in the management information.
